(19) United States
(12) Patent Application Publication
(10) Pub. No.: US 2026/0340051 A1
(43) Pub. Date: Oct. 29, 2026

(54) TECHNOLOGIES FOR ENABLING ACCESS TO CUSTOMER INTENT DATA ACROSS SUBSYSTEMS OF A CONTACT CENTER SYSTEM

(71) Applicant: Genesys Cloud Services, Inc., Menlo Park, CA (US)

(72) Inventors: Hugh Duffy, Galway (IE); Orla Roisin Coleman, Galway (IE); Cillian Day, Galway (IE)

(21) Appl. No.: 19/193,434

(22) Filed: Apr. 29, 2025

(51) Int. Cl. G06F 16/9535; G06F 40/35; G06Q 30/015

(52) U.S. Cl. CPC G06F 16/9535; G06F 40/35; G06Q 30/015

(57) ABSTRACT

A method for enabling access to customer intent data across subsystems in a contact center system includes receiving a request via a communication channel associated with a first subsystem of a set of subsystems. The method also includes determining, by the first subsystem, an intent of a customer associated with the request. The intent is associated with a taxonomy that normalizes determinations of intent across the subsystems. The method also includes storing, in association with a contact identifier indicative of the customer, the intent data indicative of the determined intent via a system-wide interface, receiving a subsequent request associated with the customer via a second communication channel associated with a second subsystem of the set of subsystems, and reading, by the second subsystem and with the system-wide interface, the stored intent data associated with the contact identifier to continue progress towards a resolution associated with the intent.

### BACKGROUND

Contact centers may enable multiple channels through which a communication session may be conducted with a customer to resolve a question. Each communication channel may be operated by a corresponding subsystem of the contact center and each subsystem may store information associated with the communication session with the customer using a data format and interface that is unique to that subsystem. As such, information determined by one subsystem from communication via one channel may not be readily accessed and parsed by a second subsystem of the contact center if communication between the customer and the contact center continues through a second communication channel. The technical problem of enabling data generated by one subsystem to be accessed and parsed by another subsystem creates inefficiencies, such as the need for a subsystem to redetermine information that was previously determined by another subsystem of the contact center.

### SUMMARY

One embodiment is directed to a unique system, components, and methods for enabling access to customer intent data across subsystems of a contact center system. Other embodiments are directed to apparatuses, systems, devices, hardware, methods, and combinations thereof for enabling access to customer intent data across subsystems of a contact center system.

According to an embodiment, a method for enabling access to customer intent data across subsystems in a contact center system may include receiving a request via a communication channel associated with a first subsystem of a set of subsystems of a contact center system. Additionally, the method may include determining, by the first subsystem, an intent of a customer associated with the request. The intent may be associated with a taxonomy that normalizes determinations of intent across the subsystems of the contact center system. The method may also include storing, by the first subsystem and in association with a contact identifier indicative of the customer, the intent data indicative of the determined intent via a system-wide interface that is available across the set of subsystems. Further, the method may include receiving a subsequent request associated with the customer via a second communication channel associated with a second subsystem of the set of subsystems of the contact center system. The method may also include reading, by the second subsystem and with the system-wide interface, the stored intent data associated with the contact identifier to continue progress towards a resolution associated with the intent without redetermining the intent of the customer with the second subsystem.

In some embodiments, the first subsystem is different from the second subsystem and receiving the subsequent request associated with the customer via second communication channel may include receiving the subsequent request via a second communication channel that is different from the first communication channel. Each of the first communication channel and the second communication channel may be one of voice communication, video communication, text-based communication, or interaction with one or more user interface elements of a website.

In some embodiments, receiving the request may include determining the contact identifier associated with the customer. The contact identifier may include one or more of a customer name, customer phone number, or a cookie associated with the customer. In some embodiments, the contact identifier may include one or more of a customer phone number, a customer email address, a social identifier of the customer, a cookie associated with the customer, and/or an external identifier from another system.

In some embodiments, determining the intent may include utilizing a set of predefined rules or mappings of topics or segments to intents.

In some embodiments, determining the intent includes utilizing artificial intelligence based natural language understanding to identify the intent and normalize the intent based on the taxonomy.

In some embodiments, the method may additionally include displaying the determined intent in a user interface for an agent assigned to communicate with the customer.

In some embodiments, the method may additionally include storing, with the system-wide interface, updated intent data to indicate resolution of the intent based on communication with the customer via the second communication channel associated with the second subsystem of the contact center system.

In some embodiments, the method may additionally include storing, by the first subsystem and in association with the request, a first timestamp for the determined intent. The method may also include storing, by the second subsystem and in association with the subsequent request, a second timestamp for the determined intent.

In some embodiments, the method may include determining, as a function of an allowed intent lifetime, whether the stored intent data represents an expired intent. The method may also include storing, in response to a determination that the stored intent data represents an expired intent, data indicative of expiration of the expired intent.

In some embodiments, the method may also include querying, in association with the request or the second request, the contact center system using the system-wide interface for a stored intent associated with the contact identifier and excluding, in the query, intent data that has been designated as expired.

According to another embodiment, a system for enabling access to customer intent data across subsystems may include a set of multiple subsystems, at least one processor, and at least one memory comprising a plurality of instructions stored thereon that, in response to execution by the at least one processor, causes the system to receive a request via a communication channel associated with a first subsystem of the set of subsystems. The plurality of instructions may additionally cause the system to determine, with the first subsystem, an intent of a customer associated with the request. The intent may be associated with a taxonomy that normalizes determinations of intent across the set of subsystems. Additionally, the instructions may cause the system to store, with the first subsystem and in association with a contact identifier indicative of the customer, the intent data indicative of the determined intent via a system-wide interface that is available across the set of subsystems, receive a subsequent request associated with the customer via a second communication channel associated with a second subsystem of the set of subsystems of the contact center system, and read, with the second subsystem and with the system-wide interface, the stored intent data associated with the contact identifier to continue progress towards a resolution associated with the intent without a redetermination of the intent of the customer by the second subsystem.

In some embodiments, the first subsystem is different from the second subsystem and to receive the subsequent request associated with the customer via second communication channel may include to receive the subsequent request via a second communication channel that is different from the first communication channel. Each of the first communication channel and the second communication channel may include one of voice communication, video communication, text-based communication, or interaction with one or more user interface elements of a website.

In some embodiments, to receive the request may include to determine the contact identifier associated with the customer. The contact identifier may include one or more of a customer name, customer phone number, or a cookie associated with the customer.

In some embodiments, to determine the intent may include to utilize a set of predefined rules or mappings of topics or segments to intents.

In some embodiments, the plurality of instructions may further cause the system to display the determined intent in a user interface for an agent assigned to communicate with the customer.

In some embodiments, the plurality of instructions may further cause the system to store, with the system-wide interface, updated intent data to indicate resolution of the intent based on communication with the customer via the second communication channel associated with the second subsystem.

In some embodiments, the plurality of instructions may further cause the system to store, with the first subsystem and in association with the request, a first timestamp for the determined intent. The plurality of instructions may further cause the system to store, with the second subsystem and in association with the subsequent request, a second timestamp for the determined intent.

In some embodiments, the plurality of instructions may further cause the system to determine, as a function of an allowed intent lifetime, whether the stored intent data represents an expired intent. The plurality of instructions may further cause the system to store, in response to a determination that the stored intent data represents an expired intent, data indicative of expiration of the expired intent.

In some embodiments, the plurality of instructions may further cause the system to execute a query, in association with the request or the second request and with the system-wide interface, for a stored intent associated with the contact identifier and exclude, in the query, intent data that has been designated as expired.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIGS. 3-4 are a simplified flow diagram of at least one embodiment of a method for enabling access to customer intent data across subsystems in a contact center system;

FIG. 5 is a simplified flow diagram of at least one embodiment of a method for identifying expired customer intent data in a contact center system; and

FIG. 6 is a simplified diagram of a user interface, indicating a customer intent, that may be produced by the contact center system.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

It should be appreciated that the technologies described below provide the technical solution of sharing customer intent data across multiple subsystems that enable corresponding modes of interaction with a customer in a contact center system. The technologies described below provide a system and method for mapping interactions with a customer to a standardized data structure indicative of an intent of the customer. The customer intent data structure primarily indicates the reason that the customer is interacting with the business, but may include additional properties, such as a resolution status, indicative of whether the issue or reason for the customer's interaction the business has been resolved. In particular, and as a technical improvement over the conventional systems, the technologies described below enable customer intent data to be normalized and made available to multiple subsystems of the contact center system rather than being siloed to a single subsystem that handles a particular type of interaction with the customer. That is, for example, customer interactions with a web based subsystem of a contact center system may be mapped to a customer intent (e.g., apply for a loan), and that customer intent data structure may then be made available to other subsystems, such as virtual agents and human agents, through a system-wide application programming interface (API). As such, the customer intent data structure persists across interaction sessions and subsystems of the contact center system. From a technical perspective, the improvement in communication among the subsystems enables more efficient routing of the customer through a customer journey and eliminates duplicated operations that may otherwise be needed to re-determine the customer's intent when the customer switches from one form of interaction with the contact center system to another.

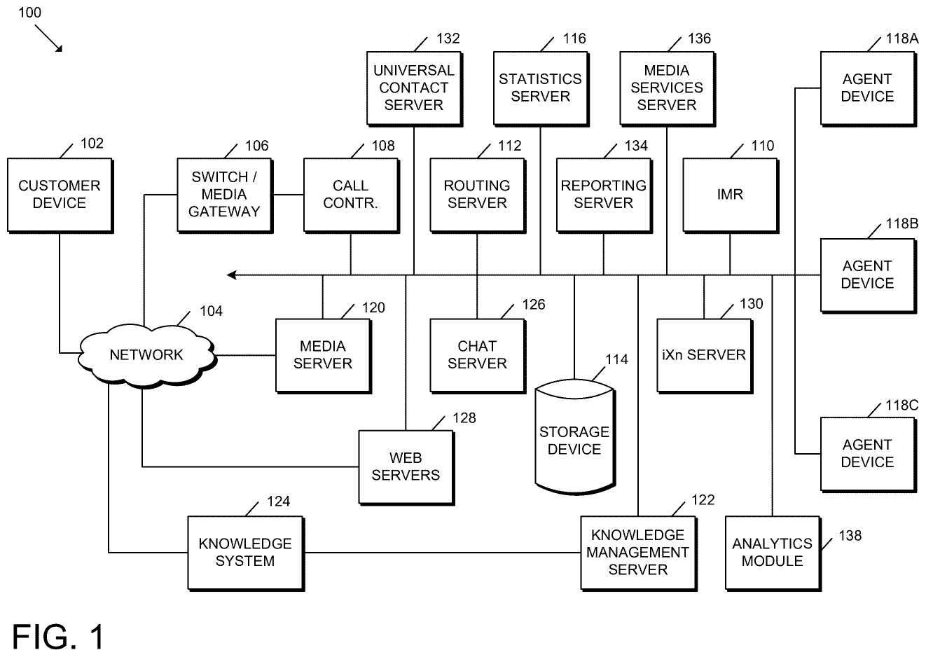

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing” or, simply, the “cloud” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

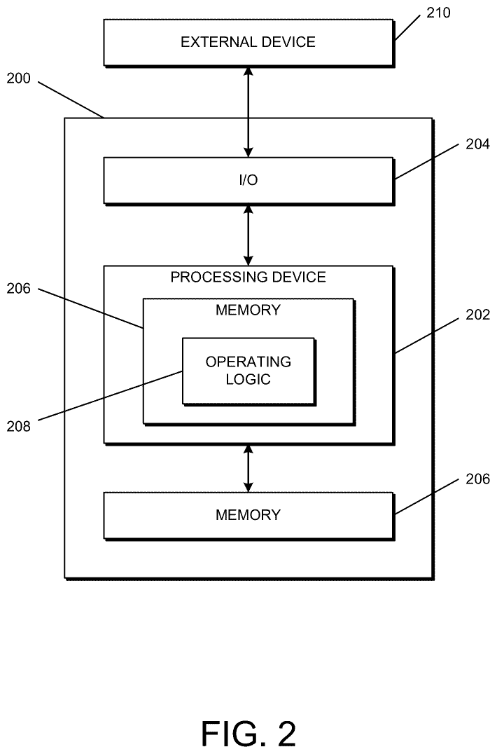

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in a customer database or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., contact identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, a system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

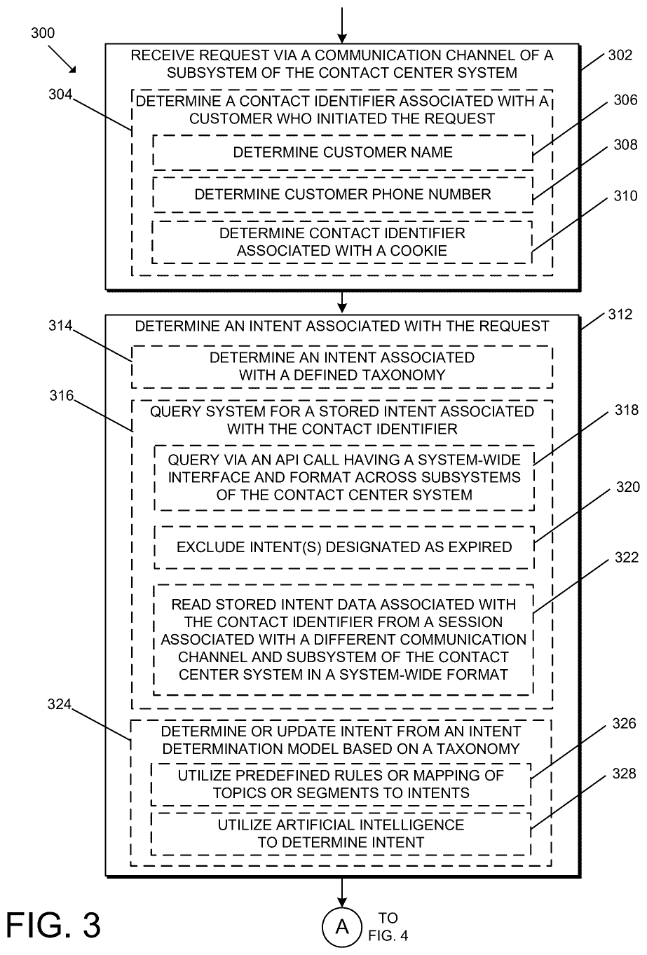

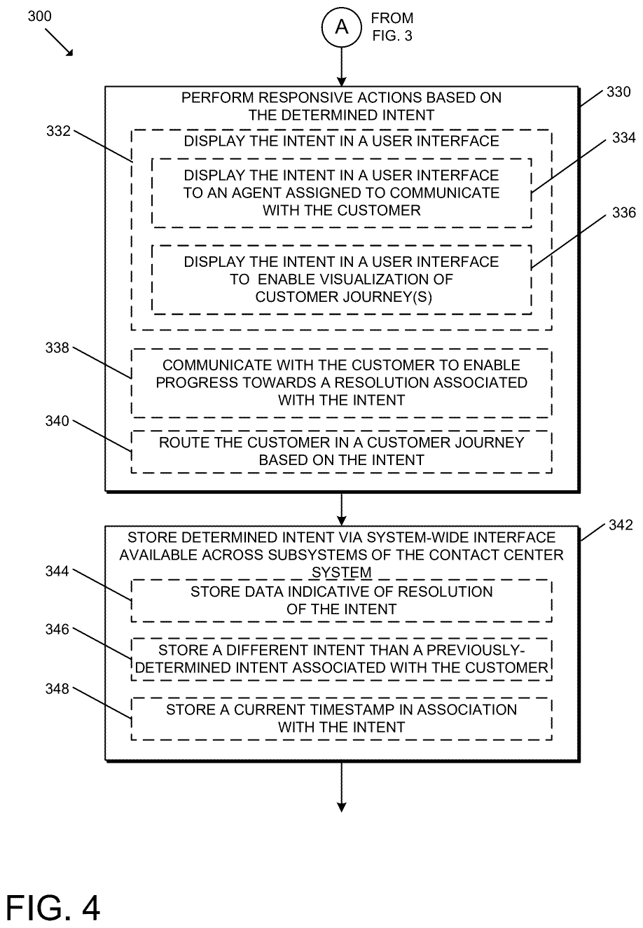

Referring now to FIGS. 3-4, in use, the contact center system 100 may execute a method 300 for enabling access to customer intent data across subsystems, such as the IMR server 110, the chat server 126, the web server(s) 128 of the contact center system 100. It should be appreciated that the particular blocks of the method 300 are illustrated by way of example, and such blocks may be combined or divided, added or removed, and/or reordered in whole or in part depending on the particular embodiment, unless stated to the contrary.

The illustrative method 300 begins with block 302 in which the system 100 receives a request via a communication channel of a subsystem of the contact center system 100. The request may be an initial interaction from a customer operating a customer device 102 to the contact center system 100 to achieve a particular goal, such as the resolution of a question. That is, the customer contacts the contact center system 100 with an intent, representing the reason that the customer is contacting the contact center system 100. As used herein, a subsystem may be, for example, a server that manages a corresponding form of interaction or communication, referred to herein as a “communication channel”, with a customer. For example, the IMR server 110, the chat server 126, the web server(s) 128 may each form a corresponding subsystem that manages a corresponding communication channel. That is, the IMR server 110 may manage communications associated with a voice-based communication channel, such as those related to voice calls made to the contact center system 100 from a customer device 102. Similarly, the chat server 126 may manage text-based communications associated with one or more chat sessions between a customer device 102 and virtual agents or human agents. Likewise, the web server(s) 128 may manage interactions or communications associated with one or more webpages, such as interactions by the customer with one or more user interface elements of one or more webpages hosted by the web server(s) 128. Those interactions may include selections of menu items, links, or other displayed user interface elements, and/or interactions with a widget, as described above.

In receiving the request, in block 304, the contact center system 100, and in particular, the subsystem corresponding to the communication channel through which the customer contacts the contact center system 100, determines a contact identifier associated with the customer who initiated the request. In doing so, the subsystem may determine a customer name, as indicated in block 306. Additionally or alternatively, the subsystem may determine a customer phone number, as indicated in block 308. In some embodiments, the subsystem may determine a contact identifier associated with a cookie, as indicated in block 310. That is, in some embodiments, the subsystem may generate a unique identifier, such as a sequence of symbols (e.g., numbers, letters, or other symbols) to be associated with the customer (e.g., the customer device 102) and transmit the unique identifier to be stored in a memory of the customer device 102 and to be queried from the customer device 102 on an as needed basis (e.g., to provide continuity as the customer device 102 interacts with a web page associated with a web server 128). As will be appreciated, the specific contact identifier determined by the subsystem associated with the request may depend on the particular communication channel through which the request was received. That is, for a voice-based request, the phone number may be readily available and may be utilized as the contact identifier while for a chat session, the customer name, which the customer may be prompted for at the beginning of the session, may be utilized. For a request initiated through a web page, a contact identifier associated with the cookie (e.g., stored by a web browser of the consumer device 102) may be utilized. In some embodiments, the system 100 may utilize a combination of user identifiers and/or may utilize another type of unique identifier for the customer, other than the customer name, phone number, or unique identifier stored in association with a cookie. For example, in some embodiments, the system 100 may utilize a login credential (e.g., a user name), an email address of the customer, or other unique identifier.

Continuing the method 300, in block 312, the contact center system 100, and in particular, the subsystem associated with the communication channel through which communication with the customer is taking place, determines an intent associated with the request. In doing so, the subsystem determines an intent that is associated with a defined taxonomy, in block 314. The taxonomy may be embodied as a set of data or rules that map intent-like objects associated with a given communication channel to a normalized intent data structure that is standardized across the subsystems of the contact center system 100. For example, some subsystems of the contact center system 100 may utilize natural language understanding to generate an inferred intent (an “NLU intent”). For example a virtualized agent (also referred to herein as a “bot”) or an artificial intelligence based assistant (referred to herein as “copilot”) may infer, from a customer's utterance (e.g., typed or spoken), an intent. However, the inferred intent from that utterance may not correspond to one of a set of defined intents established across all subsystems of the contact center system 100. Accordingly, the taxonomy may include rules or data that indicates how an inferred intent is categorized or mapped to one of a defined set of standardized or normalized intents across the contact center system 100. Similarly, a subsystem may utilize topics which may be embodied as subjects or categories within a set of communications, spoken or written, with the customer. The topics may not be recognized by other subsystems of the contact center system 100 and, accordingly, a subsystem that utilizes topics may access the taxonomy to determine how to map a determined topic to a corresponding intent that is standardized or normalized (e.g., understood by other subsystems across the contact center system 100). As another example, a subsystem for managing web-based interactions, such as the web server(s) 128, may utilize segments which may be embodied as rule-based groupings of website visitors or users who share certain behaviors, attributes, or other criteria. Through web listening operations, such a subsystem (e.g., the web server(s) 128) may track each visitor's activities, such as specific pages visited, time spent, referral source and/or others, in real time. When a visitor's behavior matches a set of defined rules for a particular segment, the subsystem classifies the visitor as part of that segment. As with the other intent-like elements discussed above, other subsystems of the contact center system 100 may not be configured to recognize segments. Accordingly, a subsystem that utilizes segments may use the taxonomy to map a determined segment to a corresponding intent that is standardized or normalized across the subsystems of the contact center system 100.

In block 316, the subsystem managing the request may query the contact center system 100 for a stored intent (e.g., stored in the storage device 114) associated with the contact identifier. In doing so, in block 318, the subsystem may submit a query via an application programming interface (API) call having a system-wide interface and format across the subsystems of the contact center system 100. That is, the same API call may be used across all of the subsystems to determine the intent associated with a given contact identifier. The contact identifier may be passed in as a parameter of the API call. In at least some embodiments, as described above, the contact identifier may differ based on the particular communication channel through which the request was initiated. Accordingly, the system 100, in response to receipt of the API call, may match a contact identifier (e.g., a phone number) passed in through the API call to a set of multiple contact identifiers (e.g., customer name, phone number, email address, etc.) that are all associated with a given customer, such as in a customer database. As such, the system 100 may resolve the corresponding customer based on any of a variety of possible contact identifiers that may be passed in through the API call. As indicated in block 320, the system 100 may exclude any intents stored in association with the contact identifier that are designated as expired. As described in more detail herein, a lifetime may be defined for intents. Accordingly, if an intent has been present in the data storage for more than the defined lifetime without being accessed in association with a communication channel, the system 100 may designate the intent as expired. In other words, the intent is understood to no longer be of relevance, either because the intent was resolved or the customer has indicated, through the absence of follow up communications associated with the intent, a lack of continued interest in the intent.

In block 322, the system 100, in response to the query (e.g., the API call), may read stored intent data (e.g., from the storage device 114) associated with the contact identifier, that was produced from a session associated with a different communication channel and subsystem of the contact center system 100. In doing so, the system 100 reads the intent data in a system-wide format. That is, the system 100 reads a normalized or standardized intent that is defined in the taxonomy from block 314, rather than an intent-like object such as a segment or category. In at least some embodiments, the system 100 may provide, in response to the query, a string or set of strings, each indicative of an intent that is defined or recognized in connection with the taxonomy described above. In addition to obtaining one or more stored intents through the query described above, or alternatively (e.g., if no intent was identified in response to the query), the subsystem associated with the present communication channel may utilize an intent determination model based on the taxonomy described above to determine or update the intent associated with the customer, as indicated in block 324. In doing so, in block 326, the subsystem of the contact center system 100 may utilize a set of one or more predefined rules or mappings of topics or segments to one or more intents, as defined in the taxonomy described above. Alternatively, the subsystem of the contact center system 100 may utilize artificial intelligence to determine (e.g., infer) the intent associated with the present communications from the customer, as indicated in block 328. For example, and as described above, the subsystem may utilize natural language understanding to infer an intent (an “NLU intent”) from the utterances of the customer and then map the inferred intent to a normalized or standardized intent based on the taxonomy described above.

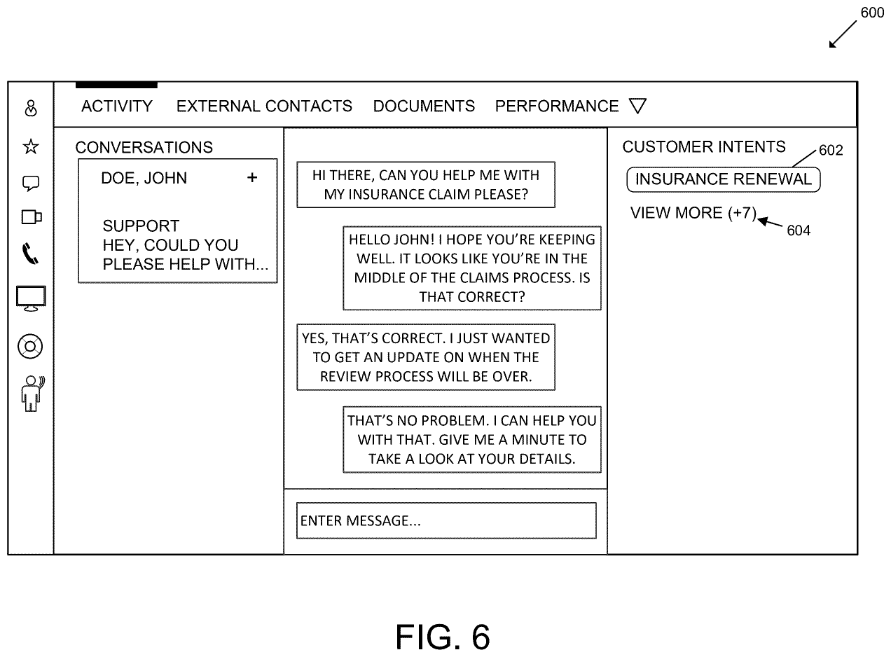

The method 300 continues in block 330 of FIG. 4, in which the subsystem of the contact center system 100 performs one or more responsive actions based on the determined intent from block 312. In doing so, the subsystem may display the intent in a user interface, in block 332. For example, the subsystem may display the intent in a user interface to an agent that has been assigned to communicate with the customer, in block 334. An embodiment of a user interface 600 that indicates a intent 602, which as described above is based on a taxonomy of intents defined across the subsystems of the contact center system 100, is shown in FIG. 6. In the user interface 600, the intent 602 is “Insurance Renewal”. Additionally, the user interface 600 includes an element 604, that if activated (e.g., selected), causes the user interface 600 to display a set of additional intents that are associated with the contact identifier. That is, in some embodiments, the system 100 may determine multiple intents associated with the same contact identifier. At least a portion of those intents may be related to previous communication sessions rather than a present communication session. Accordingly, in at least some embodiments, the system 100 may prioritize intents based on a measure of relevance, such the age of each stored intent, a similarity between a previously determined intent and an apparent intent expressed by the customer in a present communication session, and/or other factors. As such, an intent that is determined to be more relevant than other intents that are also associated with the customer may be more prominently displayed, such as in the user interface 600. Given that each intent is present in the taxonomy described above, the subsystem (e.g., the chat server 126) associated with the chat communication represented in the user interface 600 is able to utilize the intent even though the intent may have been previously determined and stored by a different subsystem of the contact center system 100 based on interactions with the customer via a different communication channel, such as voice communication with the IMR server 110, or web page interactions with the web server 128.

In some embodiments, the system 100 may display the intent(s) in a user interface that provides a visualization of customer journeys, as indicated in block 336. A customer journey may be represented by transfers of the customer communication sessions between subsystems of the contact center system 100, such as from an automated assistant accessed through a web server 128 (e.g., in a widget on a web page), to a virtual agent, to a human agent utilizing the chat server 126, and resolutions of questions, concerns, or other goals associated with one or more intents. By utilizing intents that are standardized across the subsystems of the contact center system 100 according to a taxonomy, the intents of customers, and the resolutions of those intents may be more easily tracked as the customer interacts with different subsystems and corresponding communication channels of the contact center system 100.

In performing responsive actions based on the determined intent, the system 100 communicates with the customer, via the corresponding communication channel and subsystem (e.g., IMR server 110, chat server 126, web server 128, etc.), to enable progress towards a resolution associated with the intent, as indicated in block 338. In the example above with respect to the user interface 600, an agent may communicate with the customer to renew the customer's insurance policy. By indicating that intent 602 in the user interface 600, the system 100 enables communications taking place via the corresponding subsystem and communication channel to more efficiently reach the resolution for the intent. That is, with the intent already determined (e.g., from communication that took place via a different communication channel that was managed by a different subsystem) and obtained via a system-wide interface in a standardized format (e.g., using the system-wide API call and obtaining an intent defined in the taxonomy), the subsystem (e.g., the chat server 126) associated with the chat communication represented in the user interface 600 need not facilitate any operations to re-determine the intent of the consumer. Similarly, the system 100 may route the customer among subsystems and corresponding communication channels to progress the communications towards resolution of the customer's intent, as indicated in block 340. For example, the system 100 may determine the particular virtual or human agent to which the customer should be routed based on the determined intent and an expertise or knowledge base of a given agent. Using a standardized taxonomy of intents across the contact center system 100 enables knowledge bases and areas of expertise to be easily mapped to intents, thereby providing more effective routing of a customer to a resource that can efficiently reach a resolution associated with a customer intent.

Continuing the method 300, the system 100 stores the determined intent via a system-wide interface available across the subsystems of the contact center system 100, as indicated in block 342. In doing so, in block 344, the system 100 may store data that is indicative of resolution of the intent. That is, if during the communication session, a resolution is obtained with respect to the customer intent, such as renewing the customer's insurance policy in the example above, the system 100, and in particular, the subsystem associated with the communication channel with which the communication has taken place may store, as a property of the intent associated with the contact identifier, an indication that the intent has been resolved. In some embodiments, the system 100 may treat a resolution of an intent as an expiration of the intent, such that in providing a response to a query from a communication subsystem associated with a communication channel, the system 100 may exclude any intents associated with a contact identifier that are identified as being resolved (e.g., have an associated property indicating that the intent has been resolved) in addition to excluding expired intents from the result set for the query. In some embodiments, through the course of communications via a given communication channel, the corresponding subsystem may facilitate a determination of an additional or different intent than an intent that was returned from the query (e.g., from block 316). Accordingly, the system 100 and in particular, the subsystem responsible for managing the communication via the communication channel, in block 346, may store the different or additional intent in association with the contact identifier, utilizing the system-wide interface, such as a system-wide API call. Any such intent will be consistent with the taxonomy defined across the system 100 rather than an intent-like element that is understood only by a particular subsystem, bot flow, virtual agent, or the like in the contact center system 100. Further, in storing the intent, the system 100 stores a current timestamp in association with the intent, as indicated in block 348. The timestamp may be embodied as any data that is indicative of the time at which the intent is stored, such as the present date.

In operation, the method 300 may be performed repeatedly for any given customer. That is, the system 100 may iterate through the method 300 one time and cause the customer to be transferred from one subsystem, such as the IMR server 110, to the chat server 126. As a result of the transfer, the system 100 may perform the method 300 again using the chat server 126 to obtain any intent data that was determined and stored by the IMR server 110, using the system-wide interface and taxonomy. Further, it should be appreciated that the system 100 may simultaneously perform the method 300 for other communications with other customers. Although the blocks 302-348 are described in a relatively serial manner, it should be appreciated that various blocks of the method 300 may be performed in parallel in some embodiments.

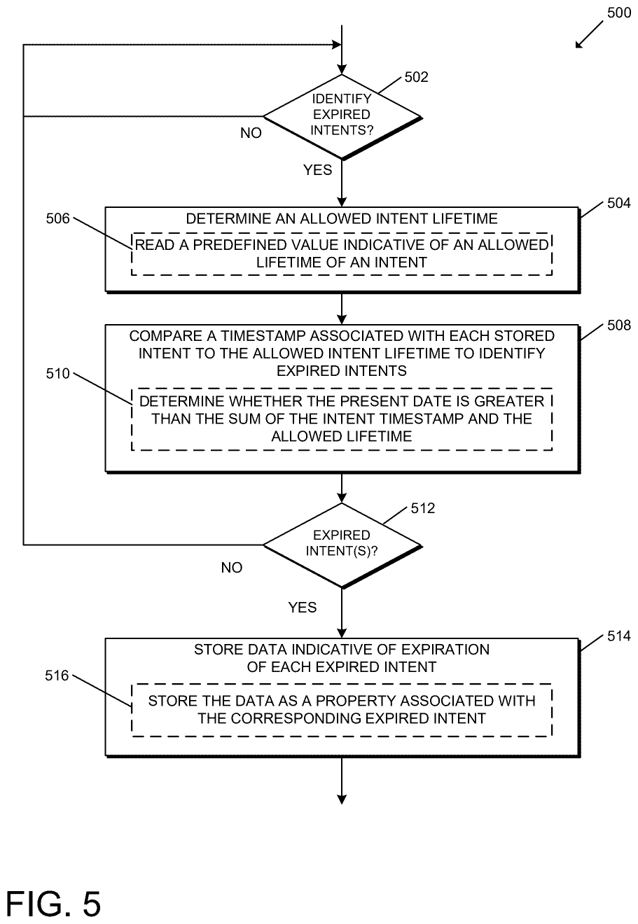

Referring now to FIG. 5, the system 100 may perform a method 500 for identifying expired customer intent data. It should be appreciated that the particular blocks of the method 500 are illustrated by way of example, and such blocks may be combined or divided, added or removed, and/or reordered in whole or in part depending on the particular embodiment, unless stated to the contrary. As described above, the system 100 may periodically analyze customer intents that have been generated and stored in a connection with contact identifiers to identify intents that have exceeded a defined lifetime and thus, may be designated as expired. By selectively designating intents as expired, due to their age, the system 100 may eliminate from result queries (e.g., as may performed in connection with block 318 of the method 300), intents associated with a given contact identifier that are likely irrelevant to a given request due to the passage of time and likelihood that the intent was resolved or the customer lost interest in the expired intent(s). The illustrative method 500 begins with block 502 in which the system 100 determines whether to identify expired intents (e.g., in the storage device 114). In the illustrative embodiment, the system 100 may perform the method 500 in response to a periodic trigger, such as a nightly scheduled job. In other embodiments, the system 100 may receive a request, such as from an administrator, to identify expired intents. Regardless, in response to a determination to identify expired intents, the method 500 advances to block 504, in which the system 100 determines an allowed intent lifetime.

In determining the allowed intent lifetime, the system 100 may read a predefined value, such as from memory 206, that is indicative of an allowed lifetime of an intent, in block 506. The intent lifetime may be defined as a setting by an administrator of the system 100 in at least some embodiments. The allowed lifetime may be defined, in some embodiments as seven days. In other embodiments, the allowed intent lifetime may be defined as 30 days or another amount of time. In some embodiments, each intent may have a different allowed intent lifetime, which may be stored as a property of that intent. That is, rather than utilizing a global allowed intent lifetime across all intents, the system 100 may attribute different allowed lifetimes to different intents, such as based on a determination that consumers typically maintain interest associated with certain types of intents longer than other types of intents. Similarly, some types of intents may require a longer amount of time to resolve and/or are less likely to be resolved by the customer (e.g., without assistance from the contact center system 100) than other intents, and as such, should remain alive (e.g., relevant) longer as a potential reason for a customer request than other types of intents.

Continuing the method 500, the system 100 compares the timestamp (e.g., stored in block 348) associated with each stored intent to the allowed lifetime to identify expired intents, as indicated in block 508. In doing so, in block 510, the system 100 may determine whether the present date, indicative of the date on which the method 500 is being performed, is greater than the sum of the timestamp associated with a given intent and the allowed lifetime for the intent. If the present date is greater than the sum of the timestamp for the intent plus the allowed lifetime for the intent, then the intent is expired. The system 100, in the illustrative embodiment, performs the above determination for every intent represented in the corresponding database (e.g., the storage device 114) that is not already designated as expired.

In block 512, in response to a determination that one or more expired intents are present, the method 500 advances to block 514 in which the system 100 stores data indicative of the expiration of each expired intent. In doing so, the system 100 may store the data indicative of the expiration of each expired intent as a property associated with that intent, in block 516. In some embodiments, the system 100 may store a value such as a Boolean value indicating whether it is true or false that the corresponding intent is expired. Additionally or alternatively, the system 100 may store the date on which the intent expired. If the system 100 determines, in block 512 that the intent(s) are not expired, the method 500 may return to block 502.

Although the blocks 502-516 are described in a relatively serial manner, it should be appreciated that various blocks of the method 500 may be performed in parallel in some embodiments.

In an example scenario illustrative of the operations of the system 100, a customer, John, visits BankABC website. In doing so, John searches for “Mortgages” and clicks on a result, which brings him to a mortgage application webpage. The system 100, and in particular, the web server 128, assigns the “Mortgage Application” segment to John. Further, the web server 128 maps the “Mortgage Application” segment to the “Apply for Loan” customer intent, based on a taxonomy. The system 100, and in particular, the web server 128, assigns the “Apply for Loan” customer intent in association with a contact identifier “externalContactId 1234” that the system 100 associated with John. Subsequently, John begins completing a form on the mortgage application webpage but encounters an issue with the form. In response, John interacts with a messaging icon on the webpage to seek help. The virtual agent asks John if he requires assistance with his application. John responds positively and the corresponding subsystem associated with the chat (e.g., the chat server 126) assigns an intent (an “NLU intent”) of “Apply for Mortgage” inferred from natural language understanding (NLU) to the “Apply for Loan” customer intent, as defined in the taxonomy shared across the subsystems of the contact center system 100. The virtual agent cannot resolve the issue and escalates to a human agent. Agent Jim receives the transfer summary from the virtual agent, which contains a reason for contact. Agent Jim can also see the mapped customer intent “Apply for Loan” in a customer journey visualization (e.g., user interface). Subsequently, Agent Jim assists John and John completes the mortgage form on the webpage. Agent Jim also confirms key contact information related to John and promotes the external contact to “curated”. The system 100 causes the customer intent “Apply for Loan” to be active for the next seven days. However, the intent may be renewed by the system 100 if John interacts with BankABC in relation to the mortgage application again in the next seven days.

Continuing the example scenario above, John calls BankABC five days later to check on the status of his mortgage application. The system 100 retrieves the active customer intents for “externalContactId 1234” and determines that there is an active “Apply for Loan” customer intent for John. The system 100 prompts John to confirm whether he has called to apply for a loan. John responds positively and the system 100 routes John's request to a “Loan Application” queue. An agent accepts a call associated with John and can see the customer intent “Apply for Loan”, and the date it was assigned, in a user interface. The agent provides an update to John on the status of the mortgage application. The corresponding subsystem detects a “Loan Application Enquiry” topic and maps that topic to the “Apply for Loan” customer intent, defined in the taxonomy. In response, the system 100 renews the active status of the customer intent for another seven days.

What is claimed is:

1. A method for enabling access to customer intent data across subsystems in a contact center system, the method comprising:
receiving a request via a communication channel associated with a first subsystem of a set of subsystems of a contact center system;
determining, by the first subsystem, an intent of a customer associated with the request, wherein the intent is associated with a taxonomy that normalizes determinations of intent across the subsystems of the contact center system;
storing, by the first subsystem and in association with a contact identifier indicative of the customer, the intent data indicative of the determined intent via a system-wide interface that is available across the set of subsystems;
receiving a subsequent request associated with the customer via a second communication channel associated with a second subsystem of the set of subsystems of the contact center system; and
reading, by the second subsystem and with the system-wide interface, the stored intent data associated with the contact identifier to continue progress towards a resolution associated with the intent without redetermining the intent of the customer with the second subsystem.

2. The method of claim 1, wherein the first subsystem is different from the second subsystem and receiving the subsequent request associated with the customer via second communication channel comprises receiving the subsequent request via a second communication channel that is different from the first communication channel, and wherein each of the first communication channel and the second communication channel is one of voice communication, video communication, text-based communication, or interaction with one or more user interface elements of a website.

3. The method of claim 1, wherein receiving the request comprises determining the contact identifier associated with the customer and wherein the contact identifier includes one or more of a customer name, customer phone number, or a cookie associated with the customer.

4. The method of claim 1, wherein determining the intent comprises utilizing a set of predefined rules or mappings of topics or segments to intents.

5. The method of claim 1, wherein determining the intent comprises utilizing artificial intelligence based natural language understanding to identify the intent and normalize the intent based on the taxonomy.

6. The method of claim 1, further comprising displaying the determined intent in a user interface for an agent assigned to communicate with the customer.

7. The method of claim 1, further comprising storing, with the system-wide interface, updated intent data to indicate resolution of the intent based on communication with the customer via the second communication channel associated with the second subsystem of the contact center system.

8. The method of claim 1, further comprising:
storing, by the first subsystem and in association with the request, a first timestamp for the determined intent; and
storing, by the second subsystem and in association with the subsequent request, a second timestamp for the determined intent.

9. The method of claim 9, further comprising:
determining, as a function of an allowed intent lifetime, whether the stored intent data represents an expired intent; and
storing, in response to a determination that the stored intent data represents an expired intent, data indicative of expiration of the expired intent.

10. The method of claim 9, further comprising querying, in association with the request or the second request, the contact center system using the system-wide interface for a stored intent associated with the contact identifier and excluding, in the query, intent data that has been designated as expired.

11. A system for enabling access to customer intent data across subsystems, the system comprising:
a set of multiple subsystems;
at least one processor; and
at least one memory comprising a plurality of instructions stored thereon that, in response to execution by the at least one processor, causes the system to:
receive a request via a communication channel associated with a first subsystem of the set of subsystems;
determine, with the first subsystem, an intent of a customer associated with the request, wherein the intent is associated with a taxonomy that normalizes determinations of intent across the set of subsystems;
store, with the first subsystem and in association with a contact identifier indicative of the customer, the intent data indicative of the determined intent via a system-wide interface that is available across the set of subsystems;
receive a subsequent request associated with the customer via a second communication channel associated with a second subsystem of the set of subsystems of the contact center system; and
read, with the second subsystem and with the system-wide interface, the stored intent data associated with the contact identifier to continue progress towards a resolution associated with the intent without a redetermination of the intent of the customer by the second subsystem.

12. The system of claim 11, wherein the first subsystem is different from the second subsystem and to receive the subsequent request associated with the customer via second communication channel comprises to receive the subsequent request via a second communication channel that is different from the first communication channel, and wherein each of the first communication channel and the second communication channel is one of voice communication, video communication, text-based communication, or interaction with one or more user interface elements of a website.

13. The system of claim 11, wherein to receive the request comprises to determine the contact identifier associated with the customer and wherein the contact identifier includes one or more of a customer name, customer phone number, or a cookie associated with the customer.

14. The system of claim 11, wherein to determine the intent comprises to utilize a set of predefined rules or mappings of topics or segments to intents.

15. The system of claim 11, wherein to determine the intent comprises to utilize artificial intelligence based natural language understanding to identify the intent and normalize the intent based on the taxonomy.

16. The system of claim 11, wherein the plurality of instructions further causes the system to display the determined intent in a user interface for an agent assigned to communicate with the customer.

17. The system of claim 11, wherein the plurality of instructions further causes the system to store, with the system-wide interface, updated intent data to indicate resolution of the intent based on communication with the customer via the second communication channel associated with the second subsystem.

18. The system of claim 11, wherein the plurality of instructions further causes the system to:
store, with the first subsystem and in association with the request, a first timestamp for the determined intent; and
store, with the second subsystem and in association with the subsequent request, a second timestamp for the determined intent.

19. The system of claim 18, wherein the plurality of instructions further causes the system to:
determine, as a function of an allowed intent lifetime, whether the stored intent data represents an expired intent; and
store, in response to a determination that the stored intent data represents an expired intent, data indicative of expiration of the expired intent.

20. The system of claim 18, wherein the plurality of instructions further causes the system to:
execute a query, in association with the request or the second request and with the system-wide interface, for a stored intent associated with the contact identifier; and
exclude, in the query, intent data that has been designated as expired.
